(19) United States
(12) Patent Application Publication
(10) Pub. No.: US 2026/0148954 A1
(43) Pub. Date: May 28, 2026

(54) FLASH LAMP

(71) Applicant: MITORIKA CO., LTD., Ibaraki (JP)

(72) Inventors: Masahiro INANIWA, Ibaraki (JP); Yuichiro SANAO, Ibaraki (JP); Takaaki SUZUKI, Ibaraki (JP)

(21) Appl. No.: 19/486,259

(22) PCT Filed: Dec. 16, 2024
(86) PCT No.: PCT/JP2024/044479

§ 371 Date: Nov. 20, 2025

(30) Foreign Application Priority Data
Dec. 27, 2023 (JP) 2023-220778

(51) Int. Cl. H01J 61/54

(52) U.S. Cl. CPC H01J 61/545

(57) ABSTRACT

A flash lamp (1) includes: a lamp housing (2) that is sealed and filled with an inert gas, a cathode (20) and an anode (30) that cause arc discharge, a trigger electrode (40) that performs preliminary discharge prior to the arc discharge, and a plurality of sparkers (60, 70) that promote ionization for starting the arc discharge. The plurality of sparkers (60, 70) are disposed at a distance from each other. At least one of the plurality of sparkers (60, 70) can be disposed close to the cathode (20). Furthermore, a plurality of the trigger electrodes (40) can be provided.

### TECHNICAL FIELD

The present disclosure relates to a flash lamp.

### BACKGROUND ART

In recent years, since a strong light emission spectrum across a wide band from an ultraviolet ray to an infrared ray is acquired, a flash lamp particularly using xenon gas as a filling inert gas is used as a light source for a spectroscopic analysis.

Example uses of the flash lamp include a water examination device, a car exhaust emission monitor, and a nitrogen oxide monitor. Since light emission is acquired from arc discharge by discharge of a charging capacitor, the flash lamp has higher light output, lower heat generation, and a longer life than a light source by a deuterium lamp and the like, and the flash lamp is energy-efficient and maintenance-free, which are factors in being entrusted with an important position as a light source.

However, the conventional flash lamp has such a fault that a flash failure phenomenon in which light emission is not achieved occurs, light emission intensity fluctuates for each piece of light emission, or an absolute value of light emission intensity decreases due to accumulation of the number of discharge times, and attempts have been made to improve the flash lamp by various methods. As one example, when a metal material in which a work function is reduced in order to facilitate emission of electrons, and a great amount of barium is contained with tungsten as a base material is used as a material of a cathode, the electrode is quickly exhausted, which results in a short life. Further, a phenomenon of fogging of a glass surface plate through which emitted light passes is more likely to occur due to sputtering accompanied by the arc discharge, and light emission intensity decreases due to accumulation of the number of discharge times.

As a solution to this, an attempt to reduce a barium amount and reduce sputtering is conceivable, but, even when an arc discharge space distance between a cathode and an anode is short, a phenomenon in which the arc discharge does not start at an initial stage due to accumulation of the number of discharge times and the like, and light emission is not achieved occurs. Thus, a measure for compensating for difficulty of discharge from the electrode by providing a plurality of trigger electrodes is taken.

However, even by this method, the flash failure phenomenon in which the arc discharge does not start and light emission is not achieved may occur. On the other hand, even when the flash failure phenomenon is avoided, a phenomenon in which a path of the arc discharge slightly varies for each piece of the discharge occurs, and, in an optical system using derived light of the flash lamp via a narrow slit, there are problems of an increase in aperture jitter in which a light amount passing through the slit seemingly fluctuates, and the like.

Patent Literature 1 describes a technique for reducing variations in a discharge path for each piece of pulse light emission, and improving light output stability. A cathode and an anode that perform arc discharge are disposed to face each other in a lamp housing filled with an inert gas, and a trigger electrode that has a shape with a plurality of needles and performs preliminary discharge prior to the arc discharge is disposed between the cathode and the anode.

Patent Literature 2 describes a technique for reducing labor, a cost, and variations in work related to a flash lamp and an attached sparker. The sparker is directly incorporated in an enclosed feedthrough header of the flash lamp.

### CITATION LIST

### Patent Literature

Patent Literature 1: Japanese U.S. Pat. No. 4,575,012
Patent Literature 2: Japanese U.S. Pat. No. 6,097,437

### SUMMARY OF INVENTION

### Technical Problem

The flash lamps in Patent Literatures 1 and 2 have improved light output stability, but a xenon flash lamp that further suppresses fluctuations in light emission intensity for each piece of light emission to a minimum, and eliminates a characteristic in which an absolute value of light emission intensity decreases due to accumulation of the number of discharge times is desired.

Further, even when a flash lamp has a long arc discharge distance between a cathode and an anode, a xenon flash lamp having the characteristics described above is desired. Furthermore, a xenon flash lamp that reduces the number of leads mounted through and led out from the flash lamp, secures a creepage distance between pads when the flash lamp is connected to a pattern of a printed board, and makes creepage discharge difficult to occur, and can also reduce a temperature rise of a cathode is desired.

The present disclosure has been made in view of the above-described problem, and has an objective to provide a flash lamp that can acquire stable light output, and can prevent a decrease in light emission intensity due to accumulation of the number of discharge times.

### Solution to Problem

In order to solve the problem described above, a flash lamp according to a first aspect of the present disclosure includes: a lamp housing in which an inert gas that is sealed and filled with an inert gas; a cathode and an anode that cause arc discharge; a trigger electrode that performs preliminary discharge prior to the arc discharge; and a plurality of sparkers that promote ionization for starting the arc discharge, wherein the plurality of sparkers are disposed at a distance from each other.

Since the cathode and the anode that cause the arc discharge and the trigger electrode that performs the preliminary discharge prior to the arc discharge are disposed in the lamp housing filled with the inert gas, and the plurality of sparkers that promotes ionization for starting the arc discharge is disposed at a distance from each other, an ionization region by an ultraviolet ray generated when the sparker emits light can be extended, and emission of electrons into plasma from the cathode, the anode, or the trigger electrode can be facilitated.

In the flash lamp, at least one of the plurality of sparkers may be disposed close to the cathode.

Since at least one of the plurality of sparkers that promotes ionization for starting the arc discharge is disposed close to the cathode, emission of electrons into plasma from the cathode being a starting point of light emission is easily, further reliably, and stably performed.

In the flash lamp, a plurality of the trigger electrodes may be provided.

Since the plurality of trigger electrodes are disposed close to an arc discharge path between the cathode and the anode in such a way that a tip of each of the trigger electrodes is substantially located on a line connecting small spherical portions of end surfaces of the cathode and the anode facing each other, stable light emission can be acquired even when an arc discharge distance between the cathode and the anode is long. The cathode, the anode, the trigger electrode, and the plurality of sparkers of the flash lamp may be disposed above a stem in the lamp housing, a lead that supplies electricity to each of the anode, the trigger electrode, and the plurality of sparkers may be electrically insulated from the stem, mounted through the stem, and led out to outside of the lamp housing, the stem may include an exhaust pipe made of metal, and the exhaust pipe may be set as a terminal that is connected and supplies electricity to the cathode.

Since the exhaust pipe made of metal is connected to the cathode in the lamp housing, a lead for the cathode can be eliminated, and the flash lamp can be made small by a reduction in the number of the leads. Further, a creepage distance between patterns of a printed board to which each of leads are attached when the leads are connected to the patterns can be increased, and thus the printed board can also be made small.

Furthermore, since heat generation of the cathode accompanied by light emission can be dissipated by the exhaust pipe made of metal, a temperature rise of the flash lamp can be reduced, and a sputter amount accompanied by the arc discharge can be reduced.

The cathode, the anode, the trigger electrode, and the plurality of sparkers of the flash lamp may be disposed above a stem in the lamp housing, a lead that supplies electricity to each of the cathode, the trigger electrode, and the plurality of sparkers may be electrically insulated from the stem, mounted through the stem, and led out to outside of the lamp housing, the stem may include an exhaust pipe made of metal, and the exhaust pipe may be set as a terminal that is connected and supplies electricity to the anode.

In this way, an effect similar to that when the exhaust pipe is set as the terminal that is connected and supplies electricity to the cathode is acquired.

A flash lamp according to a second aspect of the present disclosure includes: a lamp housing that is sealed and filled with an inert gas; a cathode and an anode that cause arc discharge; a trigger electrode that performs preliminary discharge prior to the arc discharge; and a sparker that promotes ionization for starting the arc discharge, wherein the cathode, the anode, the trigger electrode, and the sparker are disposed above a stem made of metal in the lamp housing, and a lead that supplies electricity to each of the anode, the trigger electrode, and the sparker is electrically insulated from the stem, mounted through the stem, and led out to outside of the lamp housing, the stem is connected to the cathode, and the sparker includes a sparker pin, and a conductive plate surrounding the sparker pin via an insulator and extending in a direction away from the sparker pin, and the conductive plate is connected to the stem.

In this way, a degree of freedom in an arrangement of the sparker can be increased, and, in a case of one sparker, the flash lamp can be further made simple and small.

The stem of the flash lamp may include an exhaust pipe made of metal, and the exhaust pipe may be used as a terminal that is connected and supplies electricity to the cathode.

The flash lamp further includes a cap that covers the cathode, the anode, the trigger electrode, and the sparker and is made of metal, and the stem and the cap may be electrically connected.

In this way, the cathode can be disposed close to the cap. More specifically, problems in which discharge occurs between the cathode and the cap by bringing the cathode close to the cap, a stray current flows, the flash lamp malfunctions, and the like, which occur when the cap is not electrically connected to the cathode, can be avoided.

### Advantageous Effects of Invention

A flash lamp according to the present disclosure can acquire stable light output, and can prevent a decrease in light emission intensity due to accumulation of the number of discharge times.

### BRIEF DESCRIPTION OF DRAWINGS

FIG. 1 is a partial cutout perspective view of a flash lamp according to Embodiment 1 of the present disclosure;

FIG. 2 is a partial cutout side view of the flash lamp in FIG. 1;

FIG. 3 is a plan view illustrating an arrangement of a cathode, an anode, a trigger, and sparkers of the flash lamp in FIG. 1 in a state where a transmission glass and a cap are excluded;

FIG. 4 is a plan cross-sectional view of the sparkers of the flash lamp in FIG. 1;

FIG. 5 is a side cross-sectional view of the sparkers of the flash lamp in FIG. 1;

FIG. 6 is a plan view illustrating an arrangement of the cathode, the anode, the trigger electrode, and the sparkers, which is a different arrangement from FIG. 3;

FIG. 7 is a plan view illustrating an arrangement of the cathode, the anode, the trigger electrode, and the sparkers, which is a different arrangement from FIG. 3;

FIG. 8 is a plan view illustrating an arrangement of the cathode, the anode, the trigger electrode, and the sparkers, which is a different arrangement from FIG. 3;

FIG. 9 is a plan view illustrating an arrangement of a cathode, an anode, trigger electrodes, and sparkers of a flash lamp according to an embodiment related to Embodiment 2 of the present disclosure in a state where a transmission glass and a cap are excluded;

FIG. 10 is a plan view illustrating an arrangement of the cathode, the anode, the trigger electrodes, and the sparkers, which is a different arrangement from FIG. 9;

FIG. 11 is a partial cutout perspective view of a flash lamp according to Embodiment 3 of the present disclosure;

FIG. 12 is a back view of a state where a transmission glass and a cap of the flash lamp in FIG. 11 are excluded;

FIG. 13 is a plan view illustrating an arrangement of a cathode, an anode, a trigger electrode, and a sparker of the flash lamp in FIG. 11 in a state where the transmission glass and the cap are excluded;

FIG. 14 is a block circuit diagram of a lighting device that lights the flash lamp according to Embodiment 1 or Embodiment 3 of the present disclosure; and

FIG. 15 is a partial block circuit diagram of the lighting device that lights the flash lamp according to Embodiment 2 of the present disclosure.

### DESCRIPTION OF EMBODIMENTS

Example embodiments of the present disclosure are described below with reference to drawings. In each of the drawings, common portions are denoted by the same reference sign, and duplicate description of the portions with the same reference sign is omitted. Note that, in the following embodiments, an example in which two sparkers (a first sparker 60 and a second sparker 70) are included as a plurality of sparkers is described, but the present disclosure is not limited to this, and can be applied to a flash lamp including three or more sparkers.

### Embodiment 1

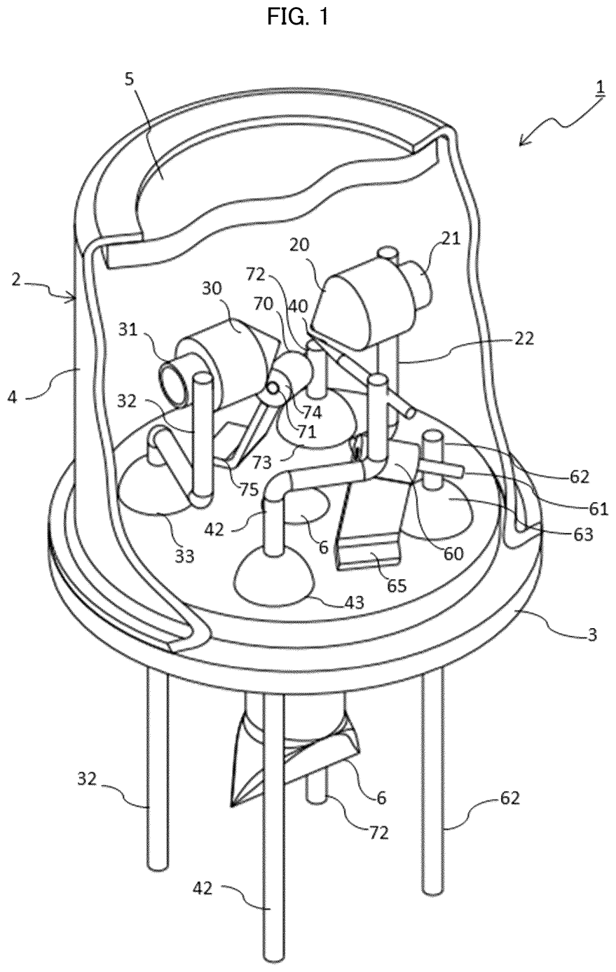

A configuration of a flash lamp 1 according to Embodiment 1 of the present disclosure is described with reference to FIGS. 1 to 8. As illustrated in FIG. 1, the flash lamp 1 includes a lamp housing that is sealed and filled with an inert gas, a cathode 20 and an anode 30 that cause arc discharge, a trigger electrode 40 that performs preliminary discharge prior to the arc discharge, and the plurality of sparkers (the first sparker 60 and the second sparker 70) that promote ionization for starting the arc discharge. The first sparker 60 and the second sparker 70 are disposed at a distance in such a way as to cause sparking without mixing and interference of discharge between the sparkers when the first sparker 60 and the second sparker 70 each discharge electricity. As the inert gas for filling, for example, xenon gas is used.

One ends of the cathode 20 and the anode 30 facing each other have a substantially conical surface shape with a small spherical tip in order to cause the arc discharge in a stable path. Lead sticks 21 and 31 constituted from molybdenum and the like are press-fitted into each of the other ends of the cathode 20 and the anode 30, and, furthermore, each of the lead sticks 21 and 31 adheres to leads 22 and 32 by spot welding and the like. The cathode 20 and the anode 30 use a material having a small work function as an electron emission material, and contains barium oxide, aluminum oxide, calcium oxide, and the like with tungsten as a base material, for example.

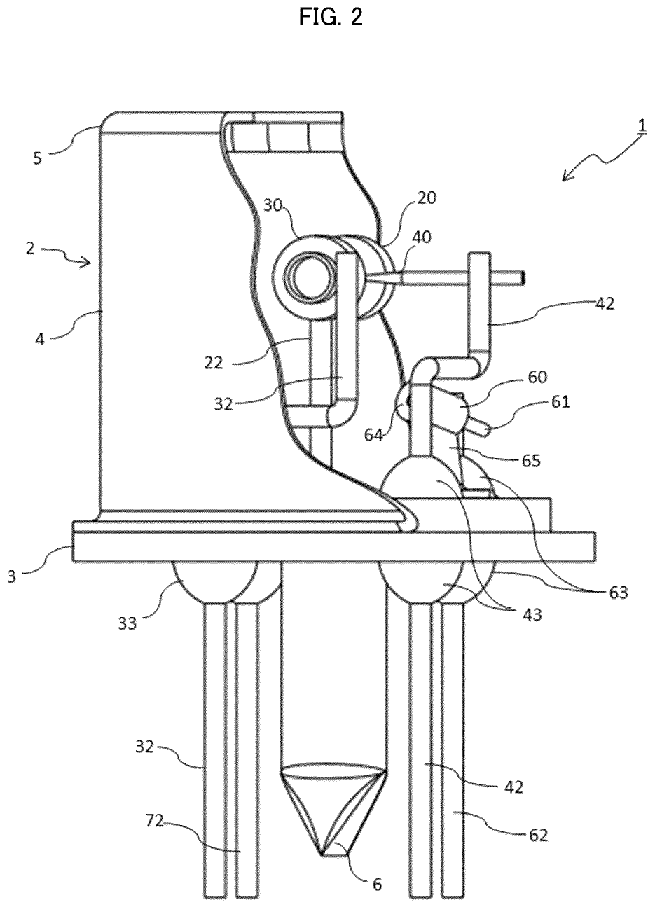

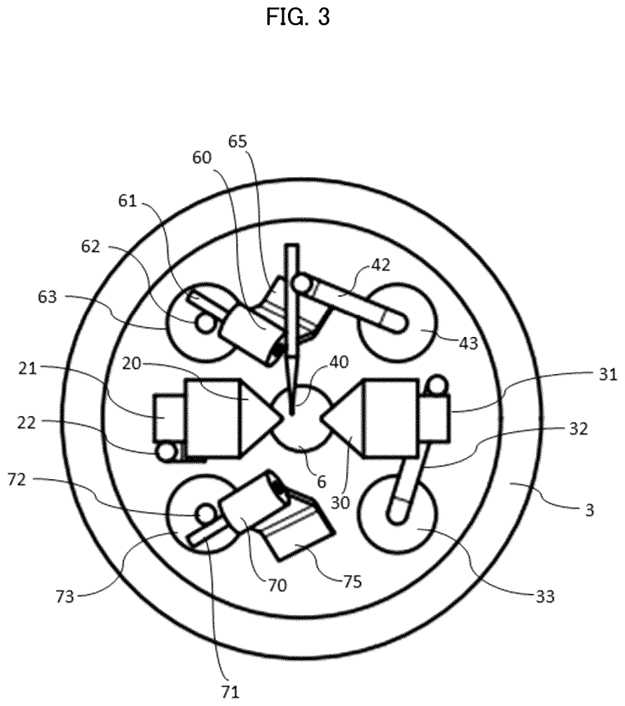

As illustrated in FIGS. 2 and 3, the lead 32 electrically connected to the anode 30 is mounted in such a way as to penetrate a stem 3 being made of metal and having a disc shape via an insulator 33 being vitreous, having a hemispherical shape, and securing a long creepage distance. The cathode 20 can also be constituted similarly to the anode 30, but, in the present embodiment, the lead 22 electrically connected to the cathode 20 is welded and adheres to a surface of the stem 3 made of metal. In other words, the stem 3 is electrically connected to the cathode 20.

The lamp housing 2 includes the stem 3, a cap 4 made of metal, and a transmission glass 5. The cathode 20, the anode 30, the trigger electrode 40, and the sparkers 60 and 70 are disposed above the stem 3 of the lamp housing 2, and the cap 4 made of metal is disposed in such a way as to cover the cathode 20, the anode 30, the trigger electrode 40, and the sparkers 60 and 70. One end of the cap 4 is fitted to an outer circumferential portion of the stem 3 made of metal, and a fitted portion is welded and sealed. Meanwhile, the other end of the cap 4 is welded to the transmission glass 5 made of a material such as quartz glass or borosilicate glass inside a flange portion, and passes arc discharge light from the cathode 20 and the anode 30. The stem 3 made of metal and the cap 4 made of metal are connected by welding, and thus the cap 4 is also electrically connected to the cathode 20. In this way, the cathode 20 can be disposed close to the cap 4. More specifically, problems in which discharge occurs between the cathode 20 and the cap 4 by bringing the cathode 20 close to the cap 4, and the like, which occur when the cap 4 is not electrically connected to the cathode 20, can be avoided.

An exhaust pipe 6 made of metal is welded to a central portion of the stem 3, an inert gas such as xenon gas is injected through the exhaust pipe 6, and the lamp housing 2 is then enclosed by sealing the exhaust pipe 6. As described above, in the present embodiment, the lead 22 connected to the cathode 20 is welded and adheres to the surface of the stem 3, and can thus be electrically connected by using, as a heat dissipation path of the cathode 20, the exhaust pipe 6 led out to the outside of the lamp housing 2. In other words, the exhaust pipe 6 can be used as a terminal that is connected and supplies electricity to the cathode 20. In the present example embodiment, such a configuration is set. Note that electrical connection to the stem 3 is not limited to the present embodiment, and a configuration in which the anode 30 is connected to the stem 3 is also possible. Further, the exhaust pipe 6 can also be used as a terminal that is connected and supplies electricity to the anode 30. In that case, the lead 22 electrically connected to the cathode 20 is mounted in such a way as to penetrate the stem 3 being made of metal and having a disc shape via an insulator being vitreous, having a hemispherical shape, and securing a long creepage distance (not illustrated).

The trigger electrode 40 is constituted from a tungsten material, and the like. As illustrated in FIG. 3, a tip portion of the trigger electrode 40 is disposed in a position slightly closer to the cathode 20 on a substantial line connecting the small spherical portions of the end surfaces of the cathode 20 and the anode 30 facing each other. Similarly to the anode 30, a lead 42 adhering to the trigger electrode 40 by spot welding and the like is mounted in such a way as to penetrate the stem 3 via an insulator 43 being vitreous, and is drawn to the outside of the lamp housing 2. Note that the leads 22, 32, and 42, leads 62 and 72, the stem 3, the cap 4, and the exhaust pipe 6 are made of metal in the present embodiment, and, for example, kovar metal is used. Note that, in the present embodiment, the stem 3, the cap 4, and the exhaust pipe 6 are made of metal, but a material is not limited to metal, and may be glass and the like.

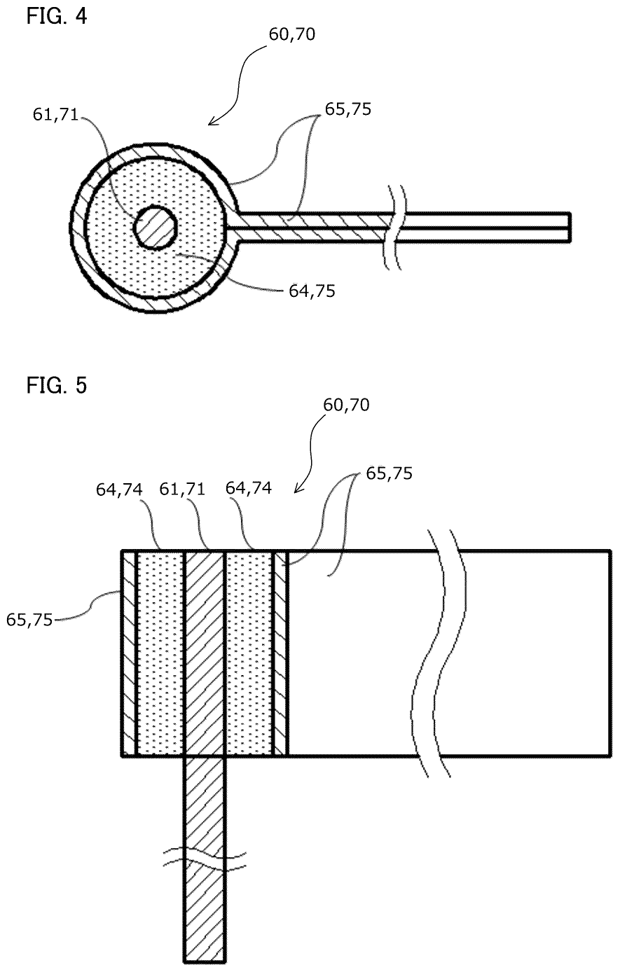

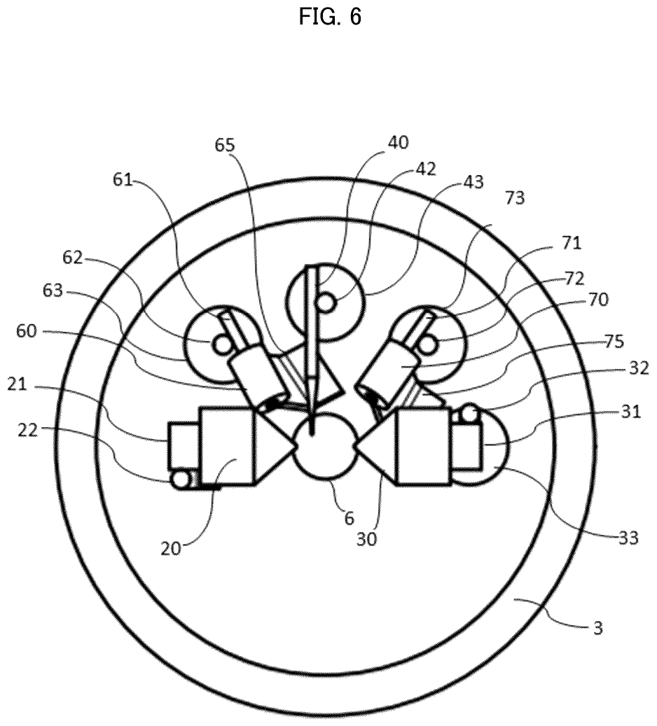

As illustrated in cross-sectional views in FIGS. 4 and 5, the first sparker 60 has a structure in which a sparker pin 61 made of a tungsten material and the like passes through an insulator 64 that is made of alumina having sufficient tracking resistance and the like and has a tubular shape, and a conductive plate 65 being a cathode surrounds the insulator 64. In other words, the sparker pin 61 is surrounded by the conductive plate 65 via the insulator 64. The conductive plate 65 is, for example, a nickel plate, and also extends in a direction away from the sparker pin 61, and an end portion of the conductive plate 65 on a side opposite to the sparker pin 61 is welded and adheres to the stem 3. One end of the sparker pin 61 is drawn to the outside of the lamp housing 2 via the lead 62 mounted in such a way as to penetrate the stem 3 via an insulator 63 being vitreous. As illustrated in FIG. 4, at the other end of the sparker pin 61, end surfaces of the sparker pin 61, the insulator 64, and the conductive plate 65 are disposed in such a way as to be substantially flush, and creepage or space discharge is caused between the sparker pin 61 and the conductive plate 65. Similarly to the first sparker 60, the second sparker 70 is also constituted from an insulator 73 being vitreous, an insulator 74 being made of alumina and the like and having a tubular shape, a conductive plate 75 made of a nickel plate and the like, the lead 72, and a sparker pin 71. In this way, the conductive plates 65 and 75 of the first sparker 60 and the second sparker 70 are configured to be welded and adhere to the stem 3 electrically connected to the cathode 20, and thus a degree of freedom in an arrangement of the first sparker 60 and the second sparker 70 can be increased.

As illustrated in FIGS. 1 and 3, in the present embodiment, the first sparker 60 and the second sparker 70 are disposed close to the cathode 20. An arrangement of the first sparker 60 and the second sparker 70 is not limited to the arrangement in FIG. 3, and only one of the first sparker 60 and the second sparker 70 may be disposed close to the cathode 20, and both may not be disposed close to the cathode 20. Further, as described above, the first sparker 60 and the second sparker 70 are disposed at a distance. When the first sparker 60 and the second sparker 70 are disposed close to each other, a malfunction phenomenon in which pieces of discharge thereof are mixed and interfere with each other occurs, and thus an extreme approach is preferably avoided. Furthermore, a similar malfunction phenomenon also occurs when the first sparker 60 and the second sparker 70 are disposed extremely close to the cathode 20 or the anode 30, and thus the first sparker 60 and the second sparker 70 are disposed at a distance in which space discharge does not occur.

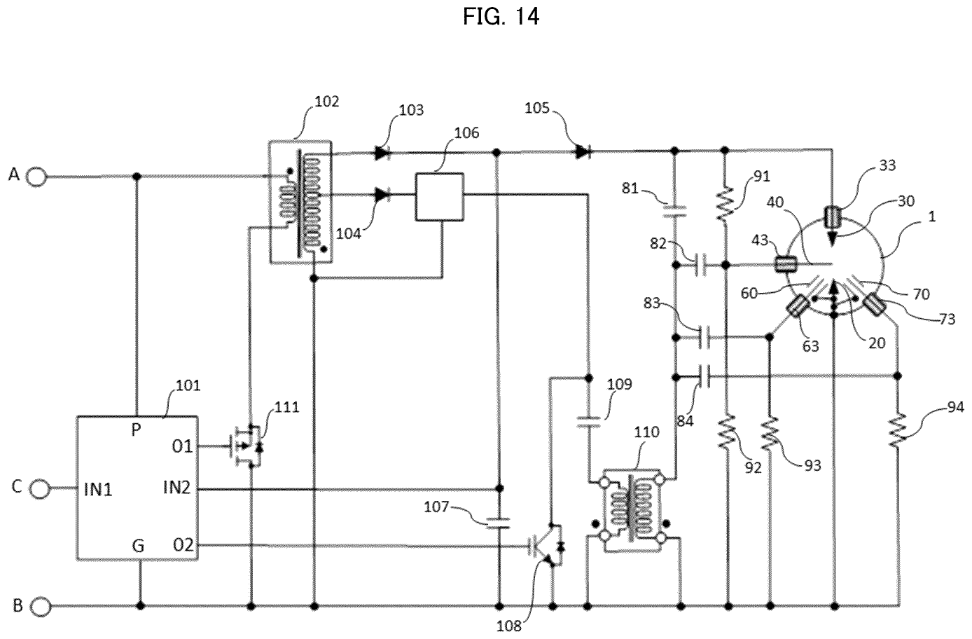

In the flash lamp 1 having the configuration as described above, a main discharge capacitor (107 in FIG. 14) connected in parallel between the cathode 20 and the anode 30 that cause the arc discharge is charged with about 300 V to 1,000 V by using the cathode 20 as a negative potential and the anode 30 side as a positive potential. In this charged state, a steep spike voltage at a negative potential of about 4,000 V is applied between the cathode 20, and the sparker pin 61 of the first sparker 60, the sparker pin 71 of the second sparker 70, the trigger electrode 40, and the anode 30 by using the cathode 20 as a reference potential.

When the steep spike voltage has a spike voltage value of approximately 500 V to 2,500 V after several hundreds of nanoseconds during a rise toward about 4,000 V, the preliminary discharge starts at each different spike voltage value between the cathode 20 and the trigger electrode 40, between the conductive plate 65 electrically connected to the cathode 20 and the sparker pin 61, and between the conductive plate 75 and the sparker pin 71, and ionization for starting the arc discharge proceeds. Subsequently, a space filled with an inert gas between the cathode 20 and the anode 30 is broken after about 1 microsecond, the arc discharge occurs, and light is emitted.

In the present embodiment, the first sparker 60 and the second sparker 70 that perform the preliminary discharge prior to the arc discharge are disposed close to the cathode 20, and thus ionization for starting the arc discharge is evenly performed in a wide range. Accordingly, emission of electrons into a plasma atmosphere from the cathode 20 toward the anode 30 is facilitated, and, for example, a malfunction phenomenon in which the arc discharge is not achieved even when a steep spike voltage is applied can be reliably avoided. Further, the cathode 20 or the anode 30 is made of a conductive material having a high proportion of tungsten, and thus emission of electrons is substantially normal, but consumption of the electrode is little. Thus, stable light output can be acquired, and a decrease in light emission intensity due to accumulation of the number of discharge times can be prevented.

Furthermore, when a conventional technique for using a plurality of the trigger electrodes 40 performing the preliminary discharge prior to the arc discharge and the present embodiment are compared, tips of the plurality of trigger electrodes 40 are disposed close to an arc discharge path between the cathode 20 and the anode 30 in the conventional technique, and thus there is a fault that a shadow of the trigger electrode 40 is reflected on a slit, depending on the arc discharge path, when a slit width of an optical system is short. On the other hand, for discharge of the first sparker 60 and the second sparker 70 in the present embodiment, in terms of a structure of the discharge, electricity is discharged between the lead 62 and the conductive plate 65 in the first sparker 60, and electricity is discharged between the lead 72 and the conductive plate 75 in the second sparker 70, and thus a discharge path is self-sufficient. Thus, a degree of freedom in an installation place of the first sparker 60 and the second sparker 70 is high, and the first sparker 60 and the second sparker 70 do not need to be placed on or close to the arc discharge path between the cathode 20 and the anode 30, and thus the fault as described above is not caused. This also applies to a case where three or more sparkers are provided.

Further, in the present embodiment, the exhaust pipe 6 welded to the central portion of the stem 3 and made of metal is used as the terminal that is led out to the outside of the flash lamp 1 and supplies electricity to the cathode 20, and thus the number of leads led out from the flash lamp 1 can be reduced, and a projection area of the flash lamp 1 can be reduced. In this way, a creepage distance between patterns of a printed board to which each of leads of the flash lamp 1 is attached when the leads are connected to the patterns can be increased, and thus a creepage discharge start voltage between the patterns of the printed board increases, and insulation processing of a printed board surface can be eliminated or simplified. Furthermore, since heat generation of the cathode 20 accompanied by light emission can be dissipated by the exhaust pipe made of metal, a temperature rise of the flash lamp 1 can be suppressed, and thus a sputter amount accompanied by the arc discharge can be reduced. In this way, using the exhaust pipe 6 made of metal as the terminal that supplies electricity to the cathode 20 is particularly useful for a flash lamp having a small outer diameter of the lamp housing 2. Also, when the exhaust pipe 6 made of metal is used as the terminal that is led out to the outside of the flash lamp 1 and supplies electricity to the anode 30, a similar effect is acquired.

Further, also in a case of one sparker, the exhaust pipe 6 made of metal can be used as the terminal that is led out to the outside of the flash lamp 1 and supplies electricity to the cathode 20 or the anode 30, and, in that case, the flash lamp 1 can be further made simple and small.

### MODIFIED EXAMPLE 1

Next, various modified examples being arrangements different from the arrangement illustrated in FIG. 3 are described. FIGS. 6 to 8 are plan views illustrating the cathode 20, the anode 30, the trigger electrode 40, the first sparker 60, and the second sparker 70 in a different arrangement from FIG. 3. In the modified example illustrated in FIG. 6, the first sparker 60 is disposed close to the cathode 20, the second sparker 70 is disposed close to the anode 30, and both are disposed on the trigger electrode 40 side. Also, in this arrangement, an effect similar to that in the previous embodiment (arrangement in FIG. 3) is acquired.

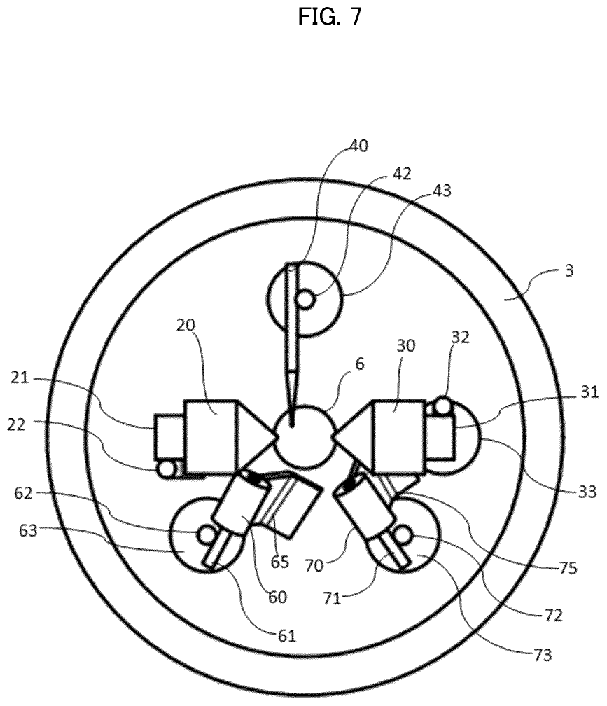

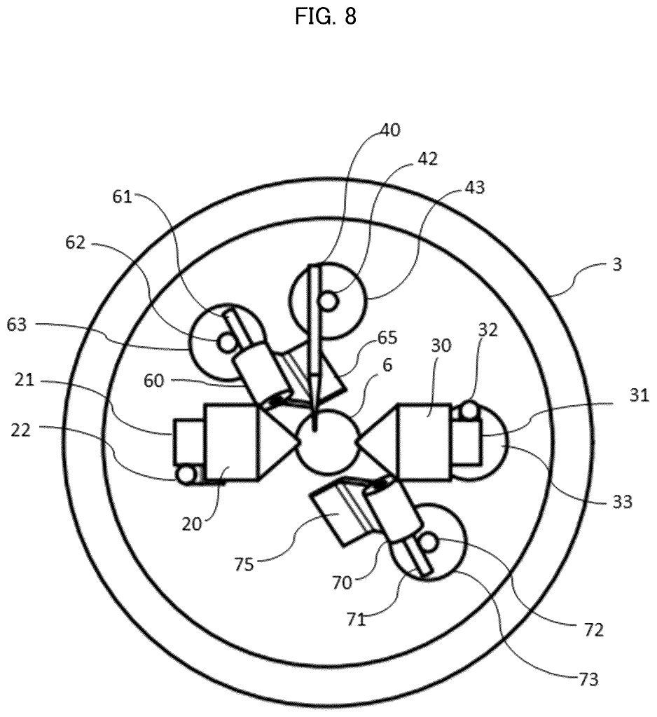

In the modified example illustrated in FIG. 7, the first sparker 60 is disposed close to the cathode 20, the second sparker 70 is disposed close to the anode 30, and both are disposed on a side facing the trigger electrode 40. In this way, in addition to the effect of the previous embodiment, assembly of the electrode is facilitated, and insulation in the lamp housing 2 and among the leads 32, 42, 62, and 72 is facilitated.

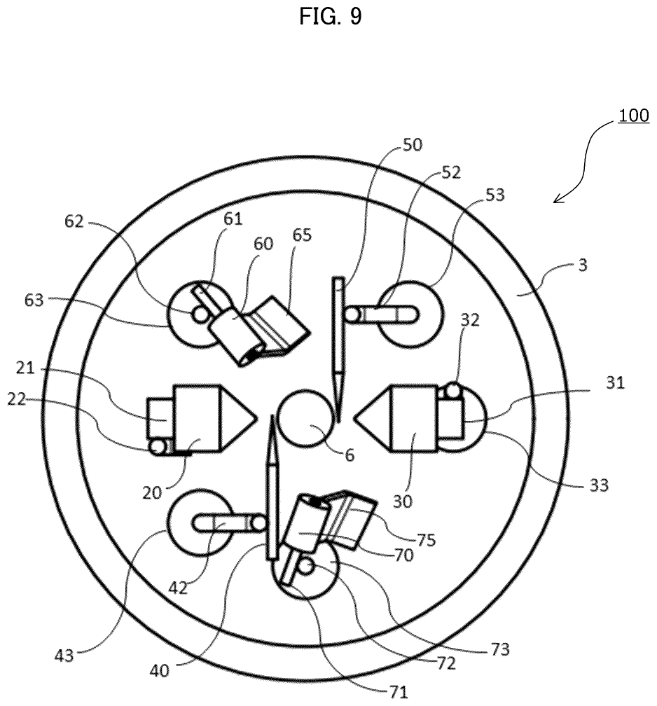

In the modified example illustrated in FIG. 8, the first sparker 60 is disposed close to the cathode 20, the second sparker 70 is disposed close to the anode 30, the first sparker 60 is disposed on the trigger electrode 40 side, and the second sparker 70 is disposed on the side facing the trigger electrode 40. In this way, in addition to the effect of the previous embodiment, assembly of the first sparker 60 and the second sparker 70 is facilitated since the first sparker 60 and the second sparker 70 are installed in separate positions, and ease of assembly of the entire flash lamp 1 improves.

### Embodiment 2

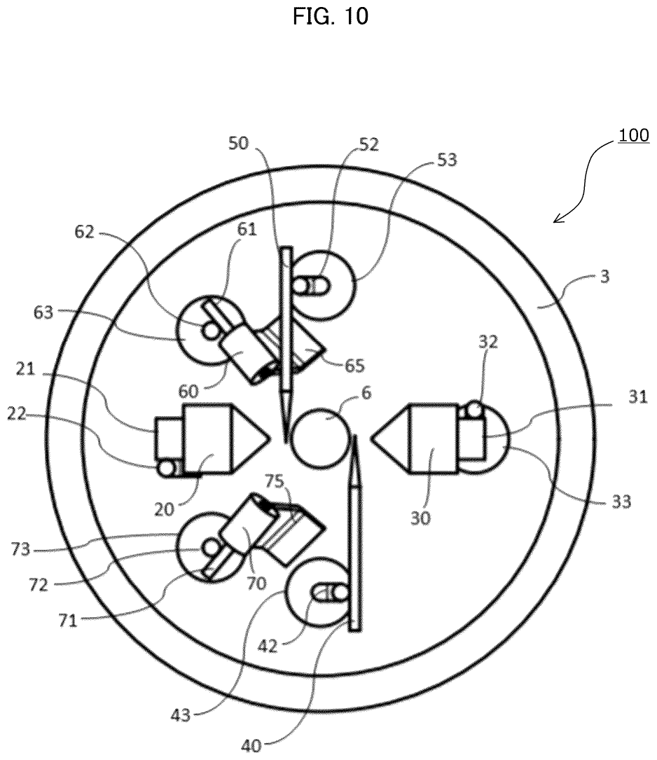

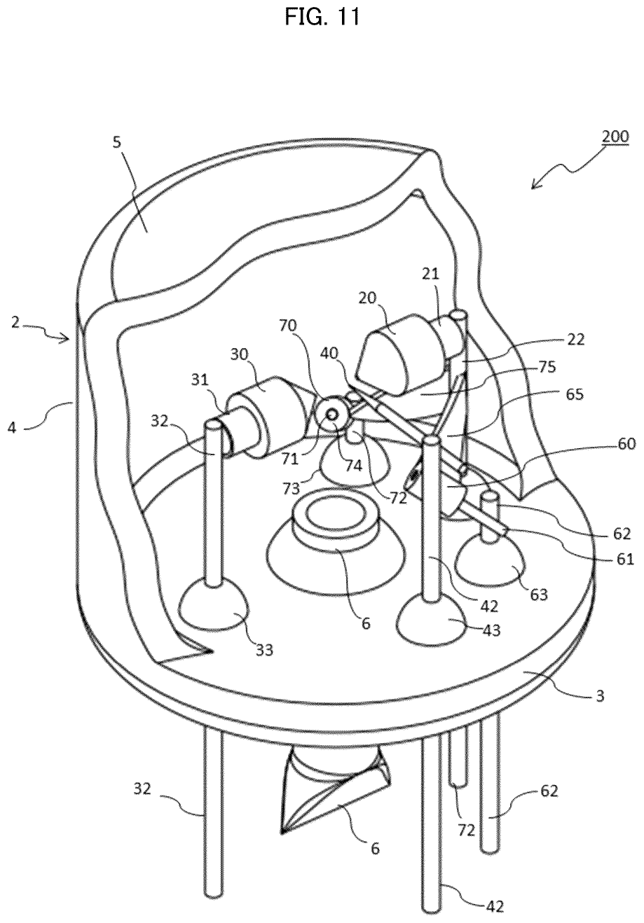

FIGS. 9 and 10 are plan views illustrating an arrangement of a cathode 20, an anode 30, a first trigger electrode 40, a second trigger electrode 50, a first sparker 60, and a second sparker 70 of a flash lamp 100 according to Embodiment 2 of the present disclosure in a state where a transmission glass 5 and a cap 4 are excluded. A configuration of a lamp housing 2, the cathode 20, the anode 30, the first trigger electrode 40, the second trigger electrode 50, the first sparker 60, the second sparker 70, and the like constituting the flash lamp 100 is similar to that in Embodiment 1, and thus description is omitted. A difference between Embodiment 2 and Embodiment 1 is a point that a plurality of trigger electrodes are provided. FIGS. 9 and 10 illustrate the flash lamp 100 in which a distance (anode-cathode distance) between tips of the cathode 20 and the anode 30 is greater than that in Embodiment 1. In a case of the flash lamp 100 having such a great anode-cathode distance, arc discharge can be facilitated by providing two trigger electrodes. In the examples in FIGS. 9 and 10, two trigger electrodes are provided, but three or more may be provided. The two trigger electrodes in the present embodiment are each the first trigger electrode 40 (the trigger electrode 40 in FIGS. 3 to 8) and the second trigger electrode 50.

In the example illustrated in FIG. 9, the second trigger electrode 50 has a configuration and a structure similar to those of the first trigger electrode 40, and a tip of the second trigger electrode 50 is disposed in a position on a substantial line connecting small spherical portions of end surfaces of the cathode 20 and the anode 30 facing each other. Similarly to the first trigger electrode 40, a lead 52 adhering to the second trigger electrode 50 by spot welding and the like is mounted in such a way as to penetrate a stem 3 via an insulator 53 being vitreous, and is drawn to the outside of the lamp housing 2. The tips of the first trigger electrode 40 and the second trigger electrode 50 are disposed close to an arc discharge path between the cathode 20 and the anode 30, and thus stable light emission can also be acquired when an arc discharge distance between the cathode 20 and the anode 30 is long. FIG. 9 illustrates the example in which the first sparker 60 is disposed close to the cathode 20 and the second sparker 70 is disposed close to the anode 30. Also, in Embodiment 2, an effect of providing the two sparkers is similar to that in Embodiment 1.

In the example illustrated in FIG. 10, a configuration is similar to the example in FIG. 9 in which the second trigger electrode 50 is newly provided, but an arrangement of the first trigger electrode 40 and the second trigger electrode 50 is mainly devised. Specifically, the tip portions of the first trigger electrode 40 and the second trigger electrode 50 are assembled in positions on the substantial line connecting the small spherical portions of the end surfaces of the cathode 20 and the anode 30 facing each other while shapes of mounted lead 42 and lead 52 are almost linear. As illustrated in FIG. 10, the first sparker 60 and the second sparker 70 are disposed close to the cathode 20 in positions facing each other across the cathode 20. The flash lamp 100 in the example illustrated in FIG. 10 can also acquire an effect similar to that in the example illustrated in FIG. 9, and assembly is additionally easy.

### Embodiment 3

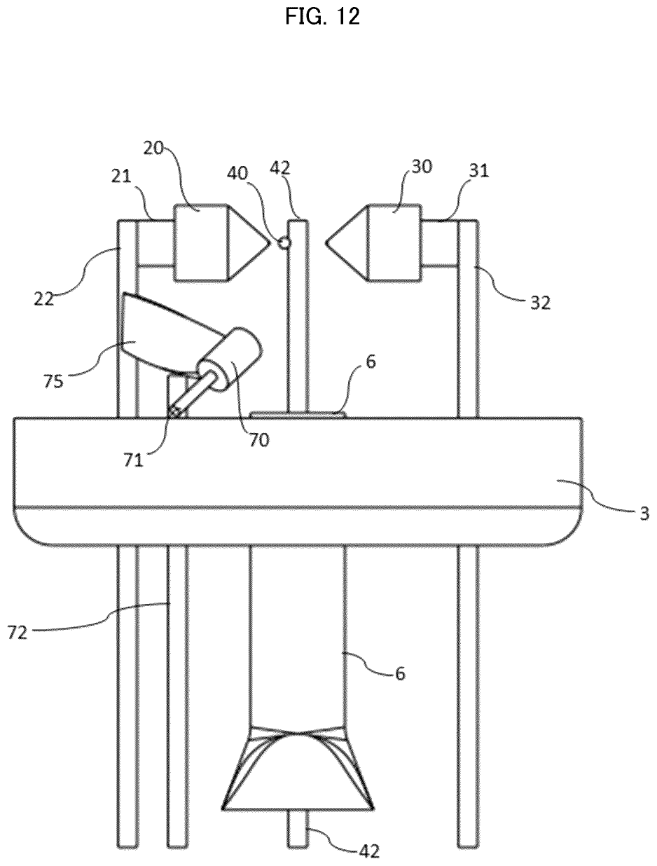

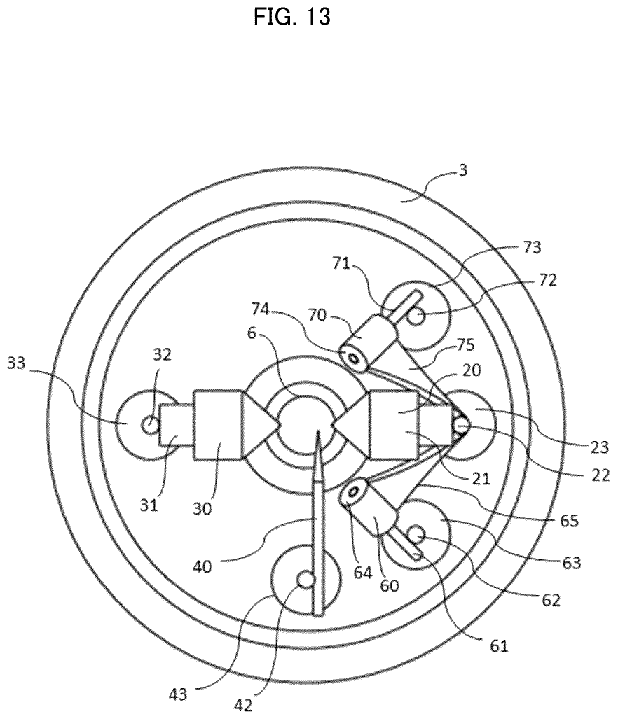

FIG. 11 is a partial cutout perspective view of a flash lamp 200 according to Embodiment 3 of the present disclosure. FIG. 12 is a back view of a state where a transmission glass 5 and a cap 4 of the flash lamp 200 are excluded, and FIG. 13 is a plan view illustrating an arrangement of a cathode 20, an anode 30, a trigger electrode 40, a first sparker 60, and a second sparker 70 in a state where the transmission glass 5 and the cap 4 of the flash lamp 200 are excluded. A difference of Embodiment 3 from Embodiment 1 is a point that a stem 3 and the cap 4 are constituted from a glass material instead of metal such as kovar metal. Accordingly, a lead 22 welded to the cathode 20 is mounted to penetrate the stem 3, and conductive plates 65 and 75 of each of the first sparker 60 and the second sparker 70 are electrically connected to the lead 22 of the cathode 20. The other configuration is similar to that in Embodiment 1, and thus description is omitted.

Making the stem 3 and the cap 4 of a glass material can prevent occurrence of discharge that would otherwise occur when the lead sticks 21 and 31 of the cathode 20 and the anode 30, the trigger electrode 40, and the like approach the stem 3 or the cap 4, which is effective in a case where the flash lamp 200 has a small diameter.

Also, in Embodiment 3, an effect of providing the two sparkers is similar to that in Embodiment 1. Note that the effect of the present disclosure can be achieved when a material of an exhaust pipe 6 is either metal or glass. Further, when an arc discharge distance between the cathode 20 and the anode 30 is long, stable light emission can also be acquired by disposing two trigger electrodes similarly to Embodiment 2.

### [Block Circuit Diagram of Lighting Device]

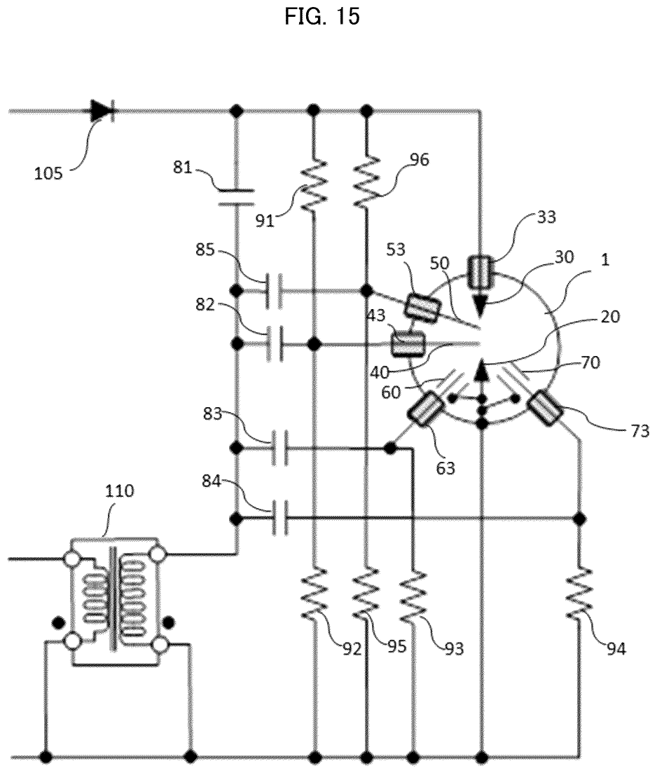

Next, a block circuit diagram of a lighting device that lights the flash lamps according to Embodiments 1 to 3 is described with reference to FIGS. 14 and 15. FIG. 14 is a block circuit diagram of the lighting device that lights the flash lamp according to Embodiment 1 or Embodiment 3. FIG. 15 is a partial block circuit diagram of the lighting device that lights the flash lamp according to Embodiment 2.

First, a configuration of the block circuit diagram in FIG. 14 is described.

An A terminal is a power input terminal and a B terminal is a GND terminal of the power terminal A, and direct-current power is supplied through the terminals. A range of supply voltage is normally from a system of 3.3 V used in a USB to a system of 24 V used in FA control. A C terminal is a pulse voltage signal input terminal that lights the flash lamp 1.

One end of a primary winding of a flyback transformer 102 is connected to the terminal A, the other end is connected to a drain of a MOSFET 111, and a source of the MOSFET 111 is connected to the terminal B. By ON/OFF switching of the MOSFET 111, the main discharge capacitor 107 is charged with a predetermined voltage between 300 V and 1,000 V in this case from a secondary winding of the flyback transformer 102 via a reverse blocking diode 103. Both ends of the main discharge capacitor 107 are connected to the anode 30 and the cathode 20 of the flash lamp 1, and constitute an arc discharge circuit.

A charging circuit of a pulse generation capacitor 109 is provided on a primary side of a trigger transformer 110 via a reverse blocking diode 104 from an intermediate winding portion of the secondary winding of the flyback transformer 102, and a regulator 106 for keeping a charging voltage of the pulse generation capacitor 109 fixed at one point between about 100 V and 200 V is provided in the middle of the charging circuit. An IGBT 108 discharges a charging charge of the pulse generation capacitor 109 to the primary side of the trigger transformer 110.

A high-voltage pulse voltage of about 4,000 V is output from a secondary winding of the trigger transformer 110, one end of capacitors 81 to 84 for direct-current blocking is connected to the secondary winding of the trigger transformer 110, and the other end is each connected to the anode 30, the trigger electrode 40, the first sparker 60, and the second sparker 70 of the flash lamp 1 as illustrated in FIG. 14. Resistors 91 to 94 for discharge having high resistance are connected in parallel with each of the capacitors 81 to 84.

In the partial block circuit diagram in FIG. 15, a portion having the same function as that in FIG. 14 is provided with the same number. In the partial block circuit diagram in FIG. 15, a capacitor 85 for direct-current blocking and resistors 95 and 96 for discharge having high resistance are added for a purpose similar to the description above for the second trigger electrode 50.

Among inputs of a controller 101, a P terminal and a G terminal are respectively connected to the A terminal and the B terminal and supplied with electricity, and a charging voltage of the main discharge capacitor 107 is referentially input to an IN2 terminal. Among outputs of the controller 101, a 01 terminal is connected to a gate of the MOSFET 111, and a 02 terminal is connected to a base of the IGBT 108. The IN1 terminal is a terminal that is connected to the C terminal and to which a trigger signal having a pulse shape for causing the flash lamp 1 to emit light is input, and the controller 101 is configured to emit light once in accordance with one input of the trigger signal.

Next, motions in FIGS. 14 and 15 are described. Until immediately before the trigger signal having the pulse shape is input from the IN1 terminal, the controller 101 refers to the charging voltage of the main discharge capacitor 107 from the IN2 terminal, and outputs a pulse width control signal from the 01 terminal to the MOSFET 111 in such a way that the charging voltage coincides with a target charging voltage being a predetermined value.

The primary winding of the flyback transformer 102 is excited by ON control of the MOSFET 111, and, when excitation of the primary winding is stopped by OFF control of the MOSFET 111, the main discharge capacitor 107 and the pulse generation capacitor 109 respectively connected via the diodes 103 and 104 are charged, from the secondary winding, with magnetic energy stored in the flyback transformer 102.

When the trigger signal is input from the IN1 terminal in a state where the main discharge capacitor 107 and the pulse generation capacitor 109 are charged with a predetermined voltage, the controller 101 stops the pulse width control signal output from the 01 terminal for about 500 microseconds in this case. In this way, charging of the main discharge capacitor 107 and the pulse generation capacitor 109 is stopped for 500 microseconds. Meanwhile, in parallel with this motion, the controller 101 simultaneously outputs a pulse signal of about 20 microseconds in this case from the 02 terminal to the IGBT 108. Then, the IGBT 108 is turned ON, a primary winding of the trigger transformer 110 is excited by the charging charge of the pulse generation capacitor 109, and a negative high-voltage steep spike voltage of about 4,000 V is applied to the capacitors 81 to 84 from the secondary winding of the trigger transformer 110. Furthermore, in FIG. 15, the spike voltage is also applied to the capacitor 85.

By the application of the spike voltage, with the cathode 20 as a reference potential, the spike voltage appears and the preliminary discharge starts all at once between the cathode 20 and the sparker pin 61 of the first sparker 60, between the cathode 20 and the sparker pin 71 of the second sparker 70, between the cathode 20 and the trigger electrode 40, and between the cathode 20 and the anode 30. Furthermore, in FIG. 15, the spike voltage also appears and the preliminary discharge starts between the cathode 20 and the second trigger electrode 50. In this way, the arc discharge occurs between the anode 30 and the cathode 20 by the above-described action mechanism, and the flash lamp 1 emits light for a few microseconds.

An inert gas in the flash lamp 1 is restored from an ion state at the time of light emission to an original inert state during a lapse of 500 microseconds. Subsequently, after output of the pulse width control signal from the 01 terminal to the MOSFET 111 restarts again, while the controller 101 refers to the charging voltage of the main discharge capacitor 107 from the IN2 terminal, the controller 101 outputs the pulse width control signal from the 01 terminal to the MOSFET 111 in such a way that the charging voltage coincides with a target charging voltage being a predetermined value.

Then, the main discharge capacitor 107 and the pulse generation capacitor 109 are charged with a predetermined voltage in a few milliseconds, preparing for the next light emission motion of the flash lamp 1.

Subsequently, when the trigger signal is input from the IN1 terminal, motions are repeated in a motion order similar to that described above in such a way that the flash lamp 1 emits light, and then the main discharge capacitor 107 and the pulse generation capacitor 109 are charged with a predetermined voltage for a few milliseconds.

The flash lamp according to the present disclosure and the circuit of the flash lamp are constituted as described above, and thus the flash lamp according to the present disclosure can acquire stable light output, and can prevent a decrease in light emission intensity due to accumulation of the number of discharge times.

The foregoing describes some example embodiments for explanatory purposes. Although the foregoing discussion has presented specific embodiments, persons skilled in the art will recognize that changes may be made in form and detail without departing from the broader spirit and scope of the present disclosure. Accordingly, the specification and drawings are to be regarded in an illustrative rather than a restrictive sense. This detailed description, therefore, is not to be taken in a limiting sense, and the scope of the present disclosure is defined only by the included claims, along with the full range of equivalents to which such claims are entitled.

This application claims the benefit of Japanese Patent Application No. 2023-220778, filed on Dec. 27, 2023, the entire disclosure of which is incorporated by reference herein.

### REFERENCE SIGNS LIST

1, 100, 200 Flash lamp
2 Lamp housing
3 Stem
4 Cap
5 Transmission glass
6 Exhaust pipe
20 Cathode
21, 31 Lead stick
22, 32, 42, 52, 62, 72 Lead
23, 33, 43, 53, 63, 73 Insulator
30 Anode
40 (First) trigger electrode
50 Second trigger electrode
60 First sparker
61, 71 Sparker pin
64, 74 Insulator
65, 75 Conductive plate
70 Second sparker
81 to 85 Capacitor
91 to 96 Resistor
101 Controller
102 Flyback transformer
103 to 105 Diode
106 Regulator
107 Main discharge capacitor
108 IGBT
109 Pulse generation capacitor
110 Trigger transformer
111 MOSFET
A Power terminal (positive)
B Power terminal (negative)
C Pulse voltage signal input terminal

1. A flash lamp comprising:
a lamp housing that is sealed and filled with an inert gas;
a cathode and an anode that cause arc discharge;
a trigger electrode that performs preliminary discharge prior to the arc discharge; and
a plurality of sparkers that promote ionization for starting the arc discharge,
wherein the plurality of sparkers are disposed at a distance from each other.

2. The flash lamp according to claim 1, wherein at least one of the plurality of sparkers is disposed close to the cathode.

3. The flash lamp according to claim 1, wherein a plurality of the trigger electrodes are provided.

4. The flash lamp according to claim 1, wherein the cathode, the anode, the trigger electrode, and the plurality of sparkers are disposed above a stem in the lamp housing, a lead that supplies electricity to each of the anode, the trigger electrode, and the plurality of sparkers is electrically insulated from the stem, mounted through the stem, and led out to outside of the lamp housing, the stem includes an exhaust pipe made of metal, and the exhaust pipe is configured as a terminal that is connected to the cathode to supply electricity.

5. The flash lamp according to claim 1, wherein the cathode, the anode, the trigger electrode, and the plurality of sparkers are disposed above a stem in the lamp housing, a lead that supplies electricity to each of the cathode, the trigger electrode, and the plurality of sparkers is electrically insulated from the stem, mounted through the stem, and led out to outside of the lamp housing, the stem includes an exhaust pipe made of metal, and the exhaust pipe is configured as a terminal that is connected to the anode to supply electricity.

6. A flash lamp comprising:
a lamp housing that is sealed and filled with an inert gas;
a cathode and an anode that cause arc discharge;
a trigger electrode that performs preliminary discharge prior to the arc discharge; and
a sparker that promotes ionization for starting the arc discharge, wherein
the cathode, the anode, the trigger electrode, and the sparker are disposed above a stem made of metal in the lamp housing, and a lead that supplies electricity to each of the anode, the trigger electrode, and the sparker is electrically insulated from the stem, mounted through the stem, and led out to outside of the lamp housing,
the stem is connected to the cathode, and
the sparker includes a sparker pin, and a conductive plate surrounding the sparker pin via an insulator and extending in a direction away from the sparker pin, and the conductive plate is connected to the stem.

7. The flash lamp according to claim 6, wherein the stem includes an exhaust pipe made of metal, and the exhaust pipe is used as a terminal that is connected to the cathode to supply electricity.

8. The flash lamp according to claim 6, further comprising a cap that covers the cathode, the anode, the trigger electrode, and the sparker and is made of metal, wherein the stem and the cap are electrically connected.

9. The flash lamp according to claim 2, wherein a plurality of the trigger electrodes are provided.

10. The flash lamp according to claim 2, wherein the cathode, the anode, the trigger electrode, and the plurality of sparkers are disposed above a stem in the lamp housing, a lead that supplies electricity to each of the anode, the trigger electrode, and the plurality of sparkers is electrically insulated from the stem, mounted through the stem, and led out to outside of the lamp housing, the stem includes an exhaust pipe made of metal, and the exhaust pipe is configured as a terminal that is connected to the cathode to supply electricity.

11. The flash lamp according to claim 3, wherein the cathode, the anode, the trigger electrode, and the plurality of sparkers are disposed above a stem in the lamp housing, a lead that supplies electricity to each of the anode, the trigger electrode, and the plurality of sparkers is electrically insulated from the stem, mounted through the stem, and led out to outside of the lamp housing, the stem includes an exhaust pipe made of metal, and the exhaust pipe is configured as a terminal that is connected to the cathode to supply electricity.

12. The flash lamp according to claim 2, wherein the cathode, the anode, the trigger electrode, and the plurality of sparkers are disposed above a stem in the lamp housing, a lead that supplies electricity to each of the cathode, the trigger electrode, and the plurality of sparkers is electrically insulated from the stem, mounted through the stem, and led out to outside of the lamp housing, the stem includes an exhaust pipe made of metal, and the exhaust pipe is configured as a terminal that is connected to the anode to supply electricity.

13. The flash lamp according to claim 3, wherein the cathode, the anode, the trigger electrode, and the plurality of sparkers are disposed above a stem in the lamp housing, a lead that supplies electricity to each of the cathode, the trigger electrode, and the plurality of sparkers is electrically insulated from the stem, mounted through the stem, and led out to outside of the lamp housing, the stem includes an exhaust pipe made of metal, and the exhaust pipe is configured as a terminal that is connected to the anode to supply electricity.

14. The flash lamp according to claim 7, further comprising a cap that covers the cathode, the anode, the trigger electrode, and the sparker and is made of metal,
wherein the stem and the cap are electrically connected.
